(19) United States
(12) Patent Application Publication
(10) Pub. No.: US 2026/0168478 A1
(43) Pub. Date: Jun. 18, 2026

(54) DRIVE TRAIN AND WIND TURBINE

(71) Applicants: ZF FRIEDRICHSHAFEN AG, Friedrichshafen (DE); ZF Wind Power Antwerpen N.V., Lommel (BE)

(72) Inventor: Warren SMOOK, Huldenberg (BE)

(21) Appl. No.: 19/420,816

(22) Filed: Dec. 16, 2025

(30) Foreign Application Priority Data
Dec. 17, 2024 (DE) 10 2024 212 027.8

(51) Int. Cl. F03D 13/10

(52) U.S. Cl. CPC F03D 13/122; F05B 2260/4031

(57) ABSTRACT

A drive train for a wind turbine includes a nacelle having a machine support structure, a generator, a gearbox disposed radially within the generator, and a rotor bearing housing configured to be mounted to the machine support structure of the nacelle. At least one bearing for rotatably supporting the rotor shaft is mountable in the rotor bearing housing. The gearbox is mountable to the machine support structure via the rotor bearing housing. The generator is mountable to the machine support structure via the rotor bearing housing.

### CROSS REFERENCE TO RELATED APPLICATIONS

This application claims benefit to German Patent Application No. DE 10 2024 212 027.8, filed on Dec. 17, 2024, which is hereby incorporated by reference herein.

### FIELD

The present disclosure relates to a wind turbine. Furthermore the present disclosure relates to a drive train of a wind turbine.

### BACKGROUND

Wind turbines are used to generate electricity from wind energy. For this purpose, wind turbines have a rotor. A rotational speed of the rotor is transmitted by a rotor shaft to a gearbox. The rotational speed of the rotor shaft is converted by the gearbox into a rotational speed suitable for driving a generator. A drive train of the wind turbine must be supported in the nacelle of the wind turbine. However, this attachment can be very complex and require many parts. In addition, maintenance and replacement of individual components of the drive train can be very costly, depending on the attachment method. EP 1 537 331 A1 describes a wind turbine in which a gearbox and a generator are separately and detachably connected to a support frame. The support frame includes a front rotor bearing and a rear rotor bearing. Therefore, the gearbox, generator, and the support frame can only be mounted together on the turbine. The drive train is therefore large and heavy, which is why transport to the installation site of the wind turbine and installation are only possible with great effort.

### SUMMARY

In an embodiment, the present disclosure provides a drive train for a wind turbine including a nacelle, a generator, a gearbox disposed radially within the generator, and a rotor bearing housing configured to be mounted to a machine support structure of the nacelle. At least one bearing for rotatably supporting the rotor shaft is mountable in the rotor bearing housing. The gearbox is mountable to the machine support structure via the rotor bearing housing. The generator is mountable to the machine support structure via the rotor bearing housing.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic illustration of a wind turbine with a drive train, according to one or more aspects of the present disclosure;

FIG. 2 is a schematic sectional view illustrating a first embodiment of the drive train for the wind turbine of FIG. 1, according to one or more aspects of the present disclosure;

FIG. 3 is a schematic sectional view illustrating a second embodiment of the drive train for the wind turbine of FIG. 1, according to one or more aspects of the present disclosure; and

FIG. 4 is a schematic sectional view illustrating a third embodiment of the drive train for the wind turbine of FIG. 1, according to one or more aspects of the present disclosure.

### DETAILED DESCRIPTION

A first aspect relates to a drive train for a wind turbine. The wind turbine includes a nacelle. The nacelle includes a machine support structure. The wind turbine may include a tower on which the nacelle is disposed. The longitudinal extension of the tower extends, for example, in a vertical direction. The nacelle may, for example, be rotatably or non-rotatably mounted on the tower. The nacelle may, for example, be disposed on top of the tower. The tower may, for example, be hollow. The tower may taper toward its upper end. The tower may, for example, be made up of a plurality of stacked tower elements. The tower may, for example, include steel and, alternatively or additionally, concrete as materials.

The drive train includes a gearbox and a generator. In addition, the drive train or the wind turbine may include a rotor. Furthermore, the drive train or the wind turbine may include a rotor shaft. The rotor may drive the generator via the gearbox to generate electrical energy. The rotor may be connected to the gearbox via the rotor shaft. The rotor, the gearbox, and the generator may, for example, be mounted to a nacelle of the wind turbine, for example, together by a main bearing arrangement. The rotor may have a horizontal or a vertical axis of rotation. The rotor may, for example, have two, three, four, or more rotor blades, which are connected to the rotor shaft via a hub. The drive train may optionally also include a brake.

The drive train includes a rotor bearing housing. At least one bearing for rotatably supporting the rotor shaft is mountable in the rotor bearing housing. It is also possible that two bearings for rotatably supporting the rotor shaft may be disposed in the rotor bearing housing. If only one bearing is provided, the rotor shaft may be supported via a further bearing in another component of the drive train, such as in a gearbox housing or a generator housing. If two bearings are provided in the housing for supporting the rotor shaft, the drive train may be free of further bearings for the rotor shaft in other components of the drive train. The bearings may form part of the drive train or be separate therefrom. The bearings may, for example, take the form of rolling-element bearings. Suitable bearings are, for example, tapered roller bearings. The rotor bearing housing may, for example, be a cast or forged part. The rotor bearing housing may be of single-or multi-part construction.

The rotor bearing housing is configured to be mounted to the machine support structure of the nacelle. The machine support structure may, for example, be a forged or cast part. The machine support structure may have interfaces for attachment of the drive train, such as support surfaces for the rotor bearing housing. The rotor bearing housing is a separate component from the machine support structure. The rotor bearing housing may, for example, be screwed or riveted to the machine support structure.

The rotor bearing housing and the one bearing, which is also referred to as the first bearing, as well as the optional second bearing in the rotor bearing housing may form a main bearing arrangement of the drive train. The wind turbine may be free of further bearings via which the drive train is supportable on the machine support structure and overall on the nacelle of the wind turbine. The main bearing arrangement may be free of further bearings. The rotor shaft may be supported on the nacelle only via the main bearing arrangement. The gearbox may, for example, also be supported on the nacelle only via the main bearing arrangement. In this case, for example, stationary components of the housing, such as a gearbox housing, are mounted to the rotor bearing housing. At least one rotating part, such as an input shaft of the gearbox, may be supported on the two bearings via the rotor shaft. Optionally, the generator may also be supported on the nacelle only via the main bearing arrangement. For this purpose, for example, stationary components of the generator, such as a generator housing, may be mounted to the rotor bearing housing. The attachment may be direct or via another component of the drive train, such as the gearbox housing.

A first of the two bearings may be disposed axially in a rotor-side end region of the rotor bearing housing. The first bearing forms, for example, a rotor-side bearing. A second of the two bearings may be disposed axially in a generator-side end region of the rotor bearing housing. The second bearing forms, for example, a generator-side bearing. The two bearings may be axially spaced from each other. The two bearings may be arranged coaxially. In the axial regions in which the two bearings are disposed, the housing may be thickened and, alternatively or additionally, reinforced. The housing may have a closed annular region in the axial regions where the two bearings are located. The axial direction, a radial direction, and a circumferential direction may be defined by the axis of rotation of the rotor shaft and, alternatively or additionally, by the axis of rotation of the respective bearings.

The gearbox may include an input shaft and an output shaft. The gearbox may include a gearbox housing. The generator may include a stator and a rotor. The generator may include a generator housing. The input shaft of the gearbox may be connected to the rotor shaft. The output shaft of the gearbox may be connected to the rotor of the generator. The generator housing may form the stator or the stator may be mounted in the generator housing. The gearbox may include a planetary gear set. A planet carrier may, for example, form the input shaft. A sun gear may, for example, form the output shaft. For example, a ring gear may be mounted in the gearbox housing.

The gearbox is mountable to the machine support structure via the rotor bearing housing. The generator is mountable to the machine support structure via the rotor bearing housing. The gearbox may, for example, by mounted to the machine support structure only via the rotor bearing housing. However, the gearbox cannot be directly connected to the nacelle. The generator may, for example, be connected to the machine support structure only via the rotor bearing housing. However, the generator cannot be directly connected to the nacelle. The generator may be connected to the rotor bearing housing directly or via an intermediate member. The intermediate member may, for example, be formed by a part of the gearbox, such as a part of the gearbox housing, or a dedicated separate connecting member. The gearbox may be connected to the rotor bearing housing directly or via an intermediate member. The intermediate member may, for example, be formed by a part of the generator, such as a part of the generator housing, or a dedicated separate connecting member. The gearbox housing and the generator housing may, for example, each be mounted directly to the rotor bearing housing, for example, each by a screw connection or by a common screw connection. For example, the gearbox housing may be mounted directly to the rotor bearing housing and the generator housing may be mounted to the rotor bearing housing via the gearbox housing, or vice versa. For example, the gearbox housing is screwed to the rotor bearing housing and the generator housing is screwed to the gearbox housing, or vice versa. This can allow for separate transport, installation, maintenance, and replacement of drive train components. For example, the gearbox can be removed from the drive train while the generator remains attached to the rotor bearing housing. This can also allow for partial assembly of the drive train and for testing of individual components. The tower and the nacelle may be installed first, together with the machine support structure, and the drive train may then be mounted thereto. For example, the generator and the gearbox may alone and alternatively or additionally be configured to be operational even in an unattached condition, i.e., without connection to the rotor bearing housing. In this case, testing can be easily performed prior to final assembly in the wind turbine.

The gearbox is disposed radially within the generator. The gearbox is, for example, disposed within a generator housing. The generator may have an axial through-opening or at least a radially central free space in which the gearbox is disposed. The generator may, for example, be disposed radially within the stator and the rotor and at least partially or completely in the same axial region. The drive train can therefore be very short axially. In addition, the generator and the gearbox can be moved axially without blocking each other, for example, for installation, replacement and, alternatively or additionally, for maintenance. The gearbox and, alternatively or additionally, the generator may be disposed axially adjacent to the rotor bearing housing, for example, on a side axially opposite the rotor. If the gearbox is configured radially within the generator, a gear ratio of the gearbox may be small compared to a design where the gearbox is axially adjacent to the generator, since the radial space is limited. Nevertheless, the generator can well withstand a consequently introduced high torque due to a large diameter. The drive train design described here allows for low maintenance and assembly costs, which may more than compensate for the potentially high acquisition costs for the large-diameter generator. In addition, the low-ratio gearbox can be cost-effective.

The generator housing may have an access opening, for example, on a side axially opposite the rotor bearing housing. The access opening allows the gearbox to be accessible therethrough, for example, for installation, replacement and, alternatively or additionally, for maintenance. The cover may be configured as a hub that acts as a connecting element between the output shaft of the gearbox and the rotor of the generator. The cover may be rotatably mounted to the remainder of the generator housing. The cover may be lockable in position on the remainder of the generator housing via the brake. This can allow the brake to be incorporated in a space-efficient manner.

An embodiment of the drive train may provide that the attachment of the generator to the machine support structure via the rotor bearing housing is releasable independently of the gearbox. For example, the attachment of the generator to the rotor bearing housing may be releasable independently of the attachment of the gearbox to the rotor bearing housing. For this purpose, for example, different fastening means may be provided for mounting the generator to the rotor bearing housing than for mounting the gearbox to the rotor bearing housing. The fastening means may, for example, take the form of screws, rivets, or clamping devices. Alternatively or additionally, the fastening means for mounting the generator to the rotor bearing housing may be accessible even when the gearbox is installed. The drive train may be configured for installation, replacement, and, alternatively or additionally, for maintenance of the generator independently of the gearbox. The generator may be removable from the drive train while the gearbox remains installed.

An embodiment of the drive train may provide that the attachment of the gearbox to the machine support structure via the rotor bearing housing is releasable independently of the generator. For example, the attachment of the gearbox to the rotor bearing housing may be releasable independently of the attachment of the generator to the rotor bearing housing. For this purpose, for example, different fastening means may be provided for mounting the gearbox to the rotor bearing housing than for mounting the generator to the rotor bearing housing. Alternatively or additionally, the fastening means for mounting the gearbox to the rotor bearing housing may also be accessible when the generator is installed. In addition, the rotor of the generator may be capable of being temporarily secured in place for removal of the gearbox, for example, by means of a screw connection to the rotor bearing housing and, alternatively or additionally, to the generator housing. The drive train may be configured for installation, replacement, and, alternatively or additionally, for maintenance, of the gearbox independently of the generator. the gearbox may be removable from the drive train while the generator remains installed.

In one embodiment, both the generator and the gearbox may be mountable to the rotor bearing housing and detachable from the rotor bearing housing independently of each other. In one embodiment, only the generator can be detached while the gearbox remains attached to the rotor bearing housing, whereas in order to detach the gearbox from the rotor bearing housing, the generator may also be detached from the rotor bearing housing. In one embodiment, only the gearbox can be detached while the generator remains attached to the rotor bearing housing, whereas in order to detach the generator from the rotor bearing housing, the gearbox may also be detached from the rotor bearing housing.

An embodiment of the drive train may provide that the rotor bearing housing has a flange. The gearbox may be mounted to the flange, for example, with its gearbox housing, and, alternatively or additionally, the generator, for example, with its generator housing. The flange may be a radially extending wall portion. The flange may project radially outwardly from a wall of the rotor bearing housing. The flange may be formed axially in the region of the second bearing, provided the second bearing is disposed in the rotor bearing housing. The flange may be formed integrally with a main part of the rotor bearing housing, in which, for example, the first bearing is disposed. The flange may be formed in an end region of the rotor bearing housing opposite the rotor. The flange may form an end face to which the generator and gearbox are mounted. The end face may face away from the rotor. For example, the gearbox housing may rest against the flange and be mounted thereto with fastening means such as screws, rivets, clamping devices, or bolts. For example, the generator housing may rest against the flange and be mounted with fastening means such as screws, rivets, clamping devices, or bolts. The fastening means may together mount the gearbox housing and the generator housing together to the flange. Alternatively, separate fastening means may be provided for mounting the gearbox housing and the generator housing. The gearbox housing may rest against the flange and be mounted thereto radially inwardly of the generator housing.

An embodiment of the drive train may provide that the drive train has a connecting member. The connecting member may be configured as a radially extending disk made, for example, of a metallic material and, alternatively or additionally, having a central axial through-opening. The connecting member element may be mounted to the rotor bearing housing. The generator and, alternatively or additionally, the gearbox may be connected to the rotor bearing housing via the connecting member. The connecting member element may be mounted to the flange. The connecting member may form an extension of the flange of the rotor bearing housing, for example, in a radial direction. The connecting member may, for example, close the generator housing and, alternatively or additionally, the gearbox housing on a side opposite the rotor bearing housing. The connecting member may form a part of the generator housing and, alternatively or additionally, of the gearbox housing. The connecting member may be disposed axially between the rotor bearing housing and the generator and, alternatively or additionally, the gearbox. The gearbox and, alternatively or additionally, the generator may be mounted to the connecting member using the same fastening means as those used to mount the connecting member to the rotor bearing housing. However, it is also possible that fastening means may be provided with which the connecting member is mounted to the rotor bearing housing separately from the gearbox and, alternatively or additionally, separately from the generator.

An embodiment of the drive train may provide that the gearbox is mounted to the connecting member. This can make the gearbox easy to mount. In this case, the connecting member and the gearbox housing can be separate components. In this case, the gearbox is, for example, mounted to the rotor bearing housing only indirectly via the connecting member and, for example, does not contact the rotor bearing housing. The connecting member element may, for example, be mounted to the ring gear of the gearbox.

An embodiment of the drive train may alternatively provide that the connecting member forms part of the gearbox housing. For example, the connecting member may form an end face of the gearbox housing that faces the rotor bearing housing. In this case, the connecting member may, for example, be detachably or permanently mounted to the remainder of the gearbox housing or formed integrally therewith.

An embodiment of the drive train may provide that the generator is mounted to the connecting member. This can make the generator easy to mount. In this case, the connecting member and the generator housing can be separate components. In this case, the generator is, for example, mounted to the rotor bearing housing only indirectly via the connecting member and, for example, does not contact the rotor bearing housing. The connecting member element may, for example, be mounted to the stator of the generator.

An embodiment of the drive train may alternatively provide that the connecting member forms part of the generator housing. For example, the connecting member may form an end face of the generator housing that faces the rotor bearing housing. In this case, the connecting member may, for example, be detachably or permanently mounted to the remainder of the generator housing or formed integrally therewith.

The connecting member may also form part of both the generator housing and the gearbox housing. This allows them to be easily mounted together to the rotor bearing housing. In this case, the generator and the gearbox can form a unit which can only be separated by partial disassembly of the gearbox and, alternatively or additionally, of the generator.

A second aspect relates to a wind turbine that includes the drive train according to the first aspect. The respective advantages and further features can be inferred from the description of the first aspect. Embodiments of the first aspect also form embodiments of the second inventive aspect and vice versa. The wind turbine includes the nacelle. The nacelle includes the machine support structure. The wind turbine may include the tower. The rotor bearing housing is mounted to the machine support structure. The gearbox is mounted to the machine support structure via the rotor bearing housing. The generator is mounted to the machine support structure via the rotor bearing housing.

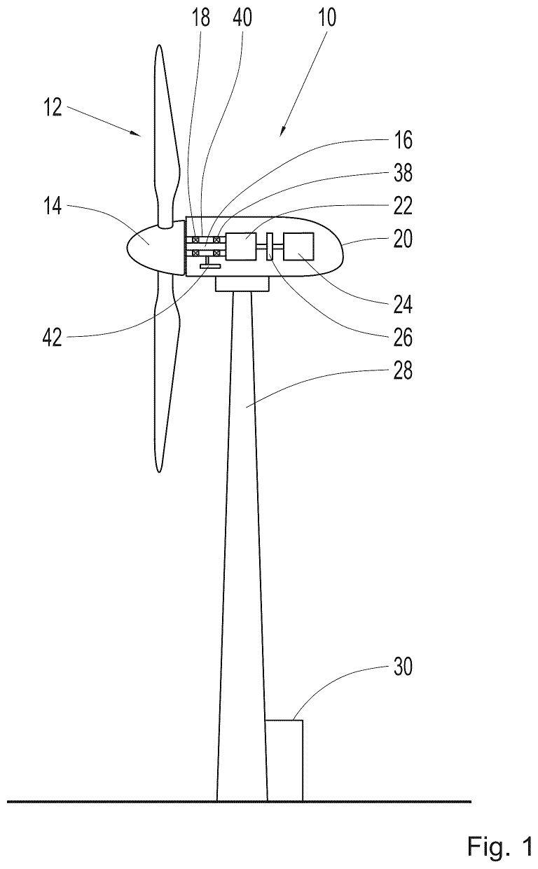

FIG. 1 illustrates a horizontal-type wind turbine 10 including a drive train. Wind turbine 10 includes a rotor 12, which is held to a rotor shaft 16 via a hub 14. The axis of rotation of rotor shaft 16 extends substantially horizontally. Rotor shaft 16 is supported in a nacelle 20 via two rolling-element bearings 18, 38. For this purpose, there is provided a rotor bearing housing 40, which is mounted to a machine support structure 42 of nacelle 20. Rotor shaft 16 is mechanically operatively connected to a generator 24 via a gearbox 22. In addition, a brake 26 is disposed in the operative connection between gearbox 22 and generator 24, the brake acting on an input shaft of generator 24. Nacelle 20 is rotatably mounted on a top end of a tower 28, which is anchored to the ground. In another embodiment, wind turbine 10 is designed as an offshore system. Wind turbine 10 has a grid connection 30 next to tower 28. A first of the rolling-element bearings, 18, faces rotor 12 and is also referred to as rotor-side bearing 18. A second of the rolling-element bearings, 38, faces generator 24 and is also referred to as generator-side bearing 38. The two rolling-element bearings 18, 38 are here configured as tapered roller bearings. At least rotor bearing housing 40, gearbox 22, and generator 24 form components of the drive train of wind turbine 10.

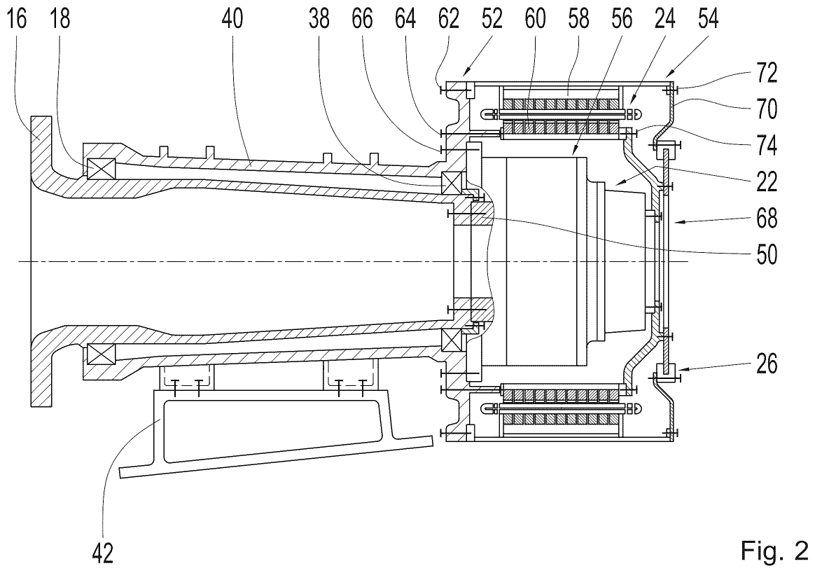

In the illustration of FIG. 1, gearbox 22 is disposed axially between rotor bearing housing 40 and generator 24. Both generator 24 and gearbox 22 are mounted to machine support structure 42 solely via rotor bearing housing 40. Generator 24 is connected to rotor bearing housing 40 indirectly via gearbox 22 and thus mounted to the machine support structure 42 via both gearbox 22 and rotor bearing housing 40. Thus, generator 24 may also be removed if gearbox 22 is to be removed for maintenance or replacement. FIGS. 2 through 4 show embodiments of the drive train with a different design of the drive train, which is also mounted to machine support structure 42 of wind turbine 10 only via rotor bearing housing 40. The differences from the generic design shown in FIG. 1 will be described below.

FIG. 2 shows a first embodiment of the drive train of wind turbine 10. Rotor bearing housing 40 is configured as a single piece, and rotor shaft 16 is supported therein via the two bearings 18, 38 mounted in rotor bearing housing 40. Machine support structure 42 is a component separate from rotor bearing housing 40 and has rotor bearing housing 40 screwed thereto. Rotor shaft 16 is mounted to an input shaft 50 of gearbox 22 by a screw connection. Input shaft 50 is here configured as a planet carrier of a planetary gear set of gearbox 22. Generator 24 includes a generator housing 54. Gearbox 22 is disposed radially within generator 24. Gearbox 22 forms a gearbox housing 56, which is completely accommodated within generator housing 54.

Rotor bearing housing 40 forms a radially outwardly extending flange 52, which is disposed axially in the region of second bearing 38. Flange 52 forms an end face facing generator 24 and gearbox 22. Generator housing 54 is mounted to flange 52 by a screw connection 62 in the radially outer region thereof. Flange 52 forms a cover for generator housing 54 axially on the rotor side thereof. A stator 58 of generator 24 is mounted to generator housing 54. A rotor 60 of generator 24 can be temporarily attached by means of a screw connection 64 radially inwardly of the attachment of generator housing 54 to flange 52. This allows rotor 60 to be secured for installation, removal, and maintenance, for example, when gearbox 22 is removed and generator 24 is to remain in place. This means that screw connection 64 is removed during operation. Gearbox housing 56 is mounted to flange 52 by means of a screw connection 66 radially inwardly of the temporary attachment of rotor 60 to flange 52 and thus also radially inwardly of the attachment of generator housing 54 to flange 52. Generator housing 54 is partially formed by a ring gear of the planetary gear set of gearbox 22 or the ring gear is at least mounted to generator housing 54.

The three screw connections 62, 64, 66 are all accessible from outside the generator housing 54 axially from a side of flange 52 facing rotor 12 and can be released independently of each other. The attachment of generator 24 to machine support structure 42 via rotor bearing housing 40 and the attachment of gearbox 22 to machine support structure 42 via rotor bearing housing 40 can thus be released independently of each other.

Generator housing 54 has an access opening on a side axially opposite rotor bearing housing 40, through which gearbox 22 fits. The access opening is closed by a hub 68. Hub 68 connects an output shaft of gearbox 22 to rotor 60 of generator 24 for transmission of driving force. Generator housing 54 has a holding element 70 which is detachably mounted to the remainder of generator housing 54 by a screw connection 72. A screw connection 74 by which hub 68 is mounted to rotor 60 becomes accessible by removing holding element 70. Brake 26 is disposed between holding element 70 and hub 68. Brake 26 allows hub 68 to be locked in position on holding element 70. Brake 26 is thus compactly incorporated and easily accessible for maintenance and replacement.

In other embodiments, second bearing 38 is mounted to gearbox housing 56 or generator housing 54.

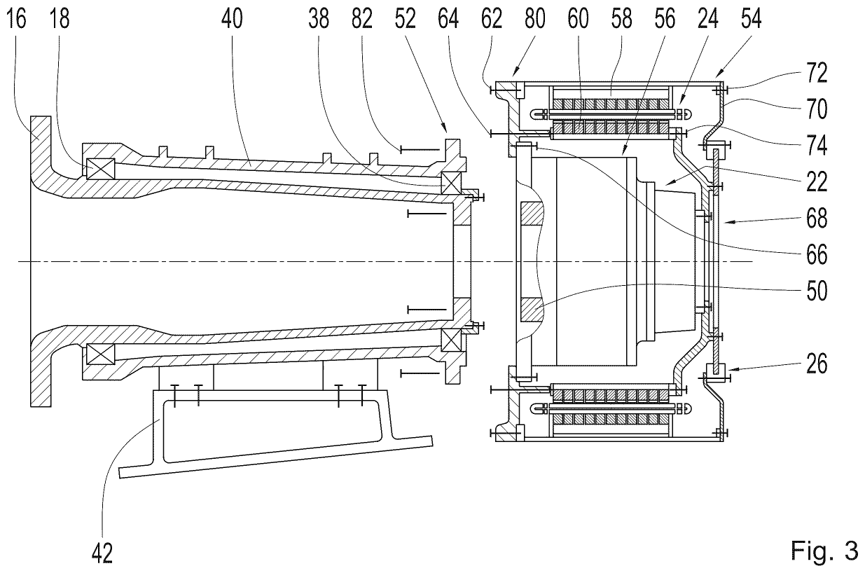

FIG. 3 illustrates a second embodiment of the drive train of wind turbine 10, showing generator 24 and gearbox 22 detached from rotor bearing housing 40. The second embodiment is similar to the first embodiment and only differences will be described. In the second embodiment, flange 52 is radially shorter and extends only approximately as far as gearbox housing 56. The radially outer portion of flange 52 in the first embodiment is now formed by a connecting member 80 that is separate from rotor bearing housing 40. Connecting member 80 is substantially formed as a radially extending disk having a central axial through-opening.

Connecting member 80 is connected to flange 52 of rotor bearing housing 40. In the exemplary embodiment shown in FIG. 3, screw connection 82 is used for this purpose. Gearbox housing 56 is now mounted to connecting piece 80 by screw connection 66 instead of directly to flange 52. In other embodiments, screw connection 82 is used both to mount gearbox housing 56 to connecting member 80 and to mount connecting member 80 to flange 52. Screw connection 82 is accessible from the outside from the direction facing rotor 12. Screw connection 66 is now accessible within generator housing 54 when the access opening is open from a direction that faces away from rotor 12. In other embodiments, flange 52 and connecting member 80 are formed in such a way that screw connection 66 is also accessible from the direction facing the rotor 12. Stator 58 and thus generator 24 are now mounted to connecting member 80 by screw connection 62 and are thus indirectly mounted to rotor bearing housing 40 via connecting member 80. Rotor 60 can now be temporarily attached to connecting member 80 by screw connection 64.

Generator 24 and gearbox 22 can thus be easily transported and installed as an assembly. This can simplify installation at the installation site. In addition, generator 24 and gearbox 22 can thus be easily tested as an assembly. In other embodiments, second bearing 38 is mounted to connecting member 80. In this way, input shaft 50 of gearbox 22 can be supported by second bearing 38 in the assembly even when gearbox 22 is not attached to rotor bearing housing 40.

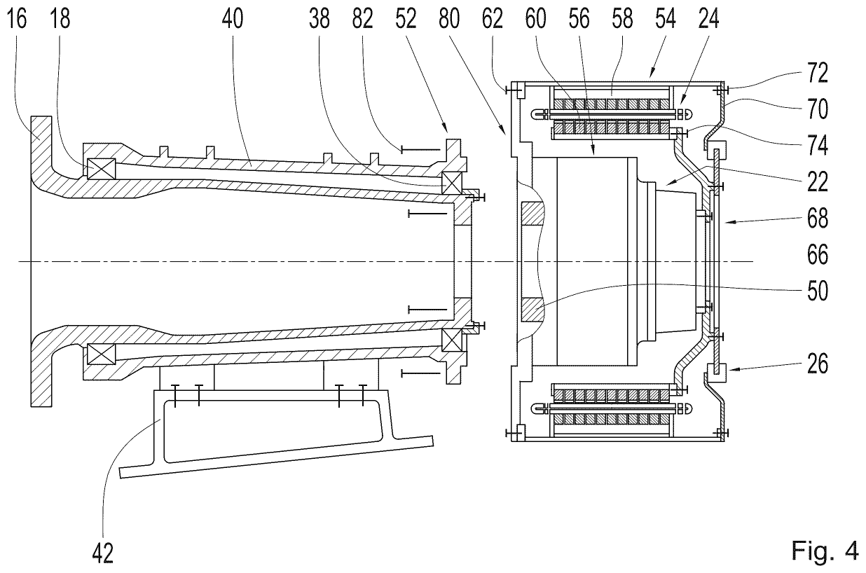

FIG. 4 illustrates a third embodiment of the drive train of wind turbine 10, showing generator 24 and gearbox 22 detached from rotor bearing housing 40. The third embodiment is similar to the second embodiment and only differences will be described. In the third embodiment, connecting member 80 is configured as a part of gearbox housing 56 that is inseparable, at least when gearbox 22 is in an operational state. In the example shown, connecting member 80 is formed integrally at least with an end region of gearbox housing 56 that faces rotor bearing housing 40.

Screw connection 66 for mounting gearbox 22 to connecting member 80 is thus omitted, which simplifies the assembly of the drive train. However, unlike in the first and second embodiments, gearbox 22 cannot be detached from rotor bearing housing 40 while generator 24 remains attached to rotor bearing housing 40. In addition, in the third embodiment shown in FIG. 4, there is no screw connection 64 for securing rotor 60 in place since gearbox 22 cannot be detached independently of generator 24. In other embodiments, however, screw connection 64 is provided to temporarily secure rotor 60 to connecting member 80 during maintenance, assembly, and transport.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

10 wind turbine
12 rotor
14 hub
16 rotor shaft
18, 38 rolling-element bearing
20 nacelle
22 gearbox
24 generator
26 brake
28 tower
30 grid connection
40 rotor bearing housing
42 machine support structure
50 input shaft
52 flange
54 generator housing
56 gearbox housing
58 stator
60 rotor
62, 64, 66, 72, 74, 82 screw connection
68 hub
70 holding element
80 connecting member

1. A drive train for a wind turbine, comprising:
a nacelle having a machine support structure;
a generator;
a gearbox disposed radially within the generator;
a rotor bearing housing configured to be mounted to the machine support structure of the nacelle; and
at least one bearing for rotatably supporting a rotor shaft being mountable in the rotor bearing housing,
wherein the gearbox is mountable to the machine support structure via the rotor bearing housing, and
wherein the generator is mountable to the machine support structure via the rotor bearing housing.

2. The drive train as recited in claim 1,
wherein attachment of the generator to the machine support structure via the rotor bearing housing is releasable independently of the gearbox.

3. The drive train as recited in claim 1,
wherein attachment of the gearbox to the machine support structure via the rotor bearing housing is releasable independently of the generator.

4. The drive train as recited in claim 1,
wherein the rotor bearing housing includes a flange to which the gearbox and the generator are mounted.

5. The drive train as recited in claim 1, further comprising:
a connecting member, the connecting member being mounted to the rotor bearing housing.

6. The drive train as recited in claim 5,
wherein the gearbox is mounted to the connecting member.

7. The drive train as recited in claim 5,
wherein the connecting member forms part of a gearbox housing.

8. The drive train as recited in claim 5,
wherein the generator is mounted to the connecting member.

9. The drive train as recited in claim 5,
wherein the connecting member forms part of a generator housing.

10. A wind turbine comprising a nacelle having a machine support structure and further comprising a drive train according to claim 1, the rotor bearing housing being mounted to the machine support structure, the gearbox being mounted to the machine support structure via the rotor bearing housing, and the generator being mounted to the machine support structure via the rotor bearing housing.
